(19) United States
(12) Patent Application Publication
(10) Pub. No.: US 2026/0242108 A1
(43) Pub. Date: Aug. 20, 2026

(54) ADJUSTABLE BUNGEE

(71) Applicant: Hampton Products International Corporation, Foothill Ranch, CA (US)

(72) Inventor: Jacob Dykstra, Lake Forest, CA (US)

(73) Assignee: Hampton Products International Corporation, Foothill Ranch, CA (US)

(21) Appl. No.: 19/057,281

(22) Filed: Feb. 19, 2025

(51) Int. Cl. B65D 63/16; B60P 7/08

(52) U.S. Cl. CPC B65D 63/16; B60P 7/0823

(57) ABSTRACT

An adjustable elastic strap comprises a cam buckle mechanism and a bungee element coupled to the cam buckle mechanism. The bungee element comprises one or more elastic cores and an outer protective jacket surrounding the one or more elastic cores. The cam buckle mechanism comprises a base and a release lever rotatably coupled to the base.

### FIELD

The subject matter herein generally relates to bungee cords, and specifically to a bungee strap with an adjustable length.

### BACKGROUND

The bungee strap is a useful device and can be used for a variety of applications including strapping down light cargo and bundling one or more items together. The bungee strap typically has a bungee or elastic portion comprising a core made of an elastic material (e.g., rubber core) and a woven jacket made of polypropylene, polyester, or other soft material surrounding the core. The bungee strap may have a hook attached at one or both ends of the bungee portion.

### BRIEF DESCRIPTION OF THE DRAWINGS

Implementations of the present technology will now be described, by way of example only, with reference to the attached figures, wherein:

FIG. 1 is an embodiment of an adjustable bungee cord in an unlatched state with a flat bungee element disengaged from a cam buckle mechanism;

FIG. 2 is a closeup of the bungee element of FIG. 1;

FIG. 3 is the adjustable bungee cord of FIG. 1 in a latched state, viewed from another aspect;

FIG. 4 is another embodiment of an adjustable bungee cord; and

FIG. 5 is yet another embodiment of an adjustable bungee cord.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

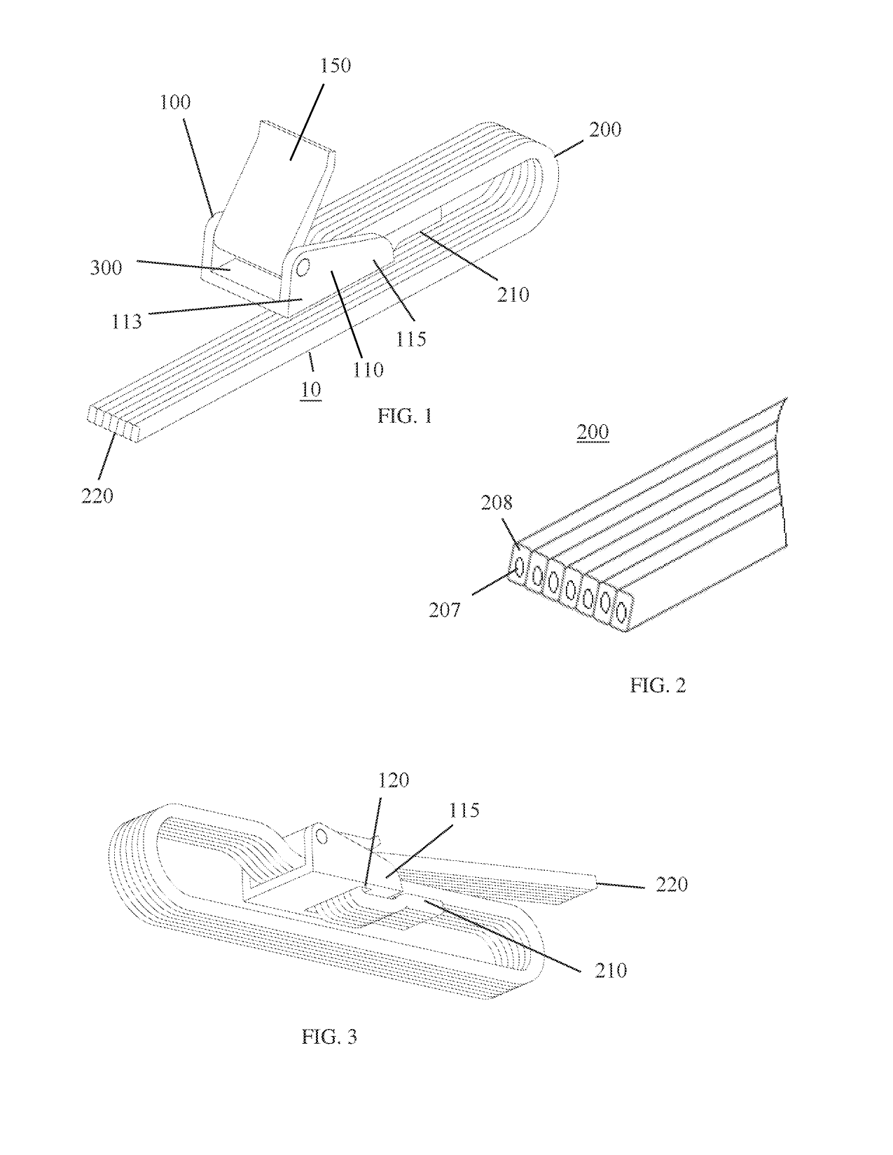

FIG. 1 illustrates an embodiment of an adjustable elastic strap or bungee strap 10 comprising a cam buckle mechanism 100 and an elastic element such as a bungee element 200 coupled to the cam buckle mechanism 100. The cam buckle mechanism 100 comprises of a base 110 and a release lever 150 rotatably coupled to the base 110 and operable between a secure state and a release state. The base 110 and the release lever 150 cooperatively form a variable opening 300 at a first end 113 of the base. The base 110 can include a slotted opening 120 at a second end 115 of the base 110.

The bungee element 200 comprises a bungee body 205 with a fixed end 210 and an opposite free end 220. Referring to FIG. 2, the bungee body 205 can be a flat rectangular strip comprising one or more elastic cores, which can be rubber cores 207, extending along a lengthwise direction and a protective outer jacket 208 surrounding the one or more rubber cores 207. In one embodiment, each of the one or more rubber cores is surrounded by an outer jacket 208, and the outer jackets 208 are stitched together. The bungee element 200 can be secured to the base 110 of the cam buckle mechanism 100 by passing the fixed end 210 through the slotted opening 120 of the base 110 and forming a closed loop by sewing or clamping the fixed end 210 to the bungee body 205 adjacent to the fixed end 210, as shown in FIG. 3.

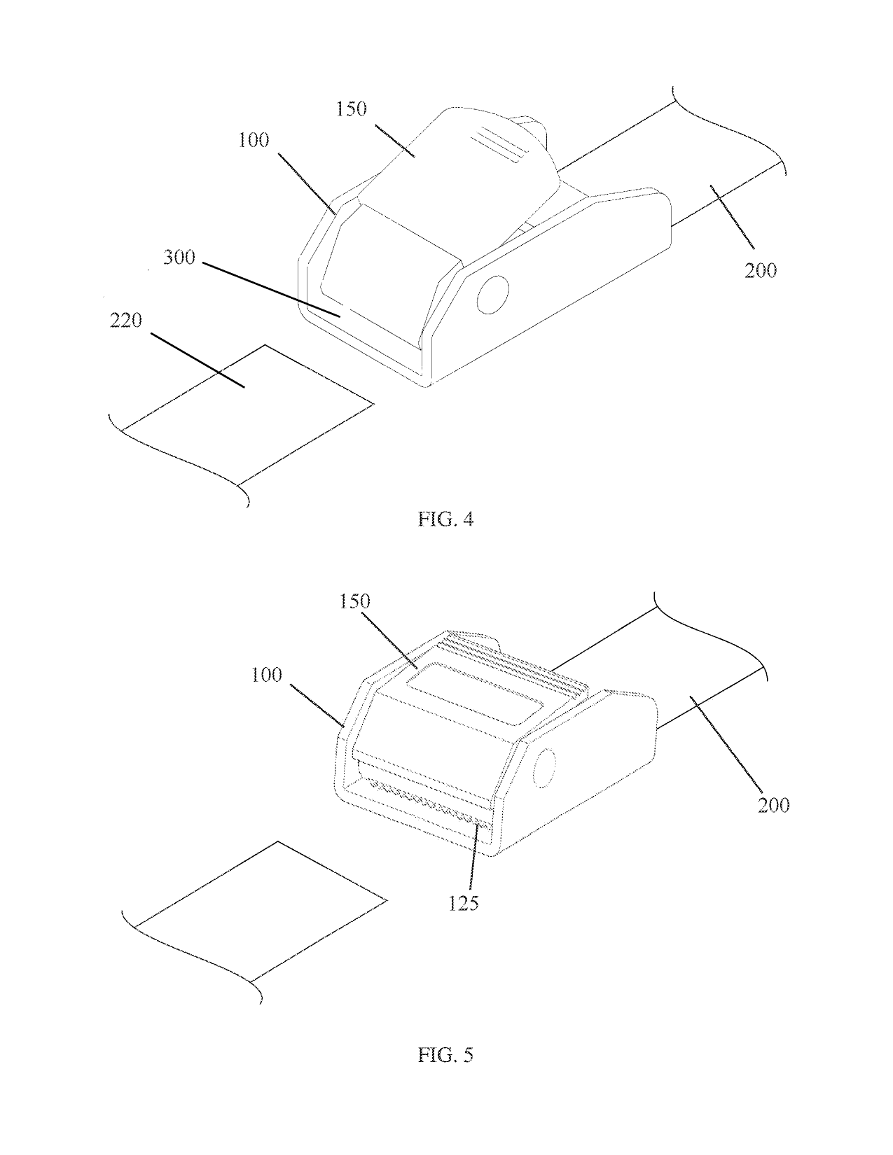

Referring to FIG. 4, the bungee strap 10 can be used to secure one or more objects together. The free end 220 of the bungee element 200 can be looped around the one or more objects and then passed through the variable opening 300 in a direction from the first end 113 towards the second end 115 of the base 110. The bungee element 200 can be pulled further to tighten the bungee strap 10 the one or more objects. The release lever 150 can then be rotated and squeezed towards the base 110 to pinch and hold the bungee element 200 to the cam buckle mechanism 100 in a secure state. The pinch between the bungee element 200 and the cam buckle mechanism can be removed to release the bungee element by rotating the release lever 150 in a direction away from the base 110.

Referring to FIG. 5, the cam buckle mechanism 100 may also include one or more restoring devices (not shown), such as a torsion spring, to urge the release lever 120 towards the secure state. The release lever 120 may have a jagged surface comprising one or more teeth 125 biting down on the bungee element to form a stronger pinch in the secure state.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An adjustable elastic strap, comprising a bungee element coupled to a cam buckle mechanism, wherein the bungee element is a flat rectangular strip, and the cam buckle mechanism comprises a base and a release lever rotatably coupled to the base.

2. The adjustable elastic strap of claim 1, wherein the bungee element comprises one or more elastic cores and an outer protective jacket surrounding the one or more elastic cores individually.

3. The adjustable elastic strap of claim 2, wherein the bungee element comprises a plurality of outer jackets stitched together.

4. The adjustable elastic strap of claim 3, wherein the one or more elastic cores are one or more rubber cores.

5. The adjustable elastic strap of claim 4, wherein the release lever has a jagged surface comprising one or more teeth.
